(19) United States
(12) Patent Application Publication
(10) Pub. No.: US 2025/0325910 A1
(43) Pub. Date: Oct. 23, 2025

(54) RECREATIONAL ENVIRONMENT FOR ENHANCING CERTAINITY OF ACQUIRING ASSETS DURING AN INTERACTIVE SESSION

(71) Applicant: Play Games24x7 Private Limited, Mumbai (IN)

(72) Inventors: Krishnendu DE, Electronic City (IN); Navaneethan SAHADEVAN, Bangalore (IN); Avin SHARMA, Mumbai (IN)

(73) Assignee: Play Games24x7 Private Limited, Mumbai (IN)

(21) Appl. No.: 19/024,441

(22) Filed: Jan. 16, 2025

(30) Foreign Application Priority Data
Apr. 18, 2024 (IN) 202421031117

(51) Int. Cl. A63F 13/537; A63F 13/35

(52) U.S. Cl. CPC A63F 13/537; A63F 13/35

(57) ABSTRACT

A multi-user recreational environment (100) to enable users to enhance certainty of acquiring requisite assets during an interactive session. The environment (100) includes an interface module (102) to provide visual components including an array of positioning units, a set of selection objects and user identifiers, to each user in the session. The environment (100) also includes a communication module (104) to generate varying selection objects for the set, at the initiation of each round of interaction in the session and to receive user input indicative of user preference from the set. The environment (100) further includes a positioning module (106) to reposition first category user identifiers, within the array of positioning units, based on the received user input and an event detector (108) to estimate a count of assets to be assigned to users associated with the repositioning of the first category user identifiers.

### FIELD OF THE INVENTION

The present invention relates to recreational environments. In particular, the present invention relates to a multi-user recreational environment to enable users to enhance certainty of acquiring requisite assets during an interactive session.

### BACKGROUND OF THE INVENTION

A popular method for people to unwind and have a good time is by attending gatherings and social events. Engaging in interactive recreational activities is a common pastime in these gatherings, as such activities foster healthy competition among the people and enhance overall enjoyment of the events. The challenge with retaining users in traditional environments stems from their limitation of interactivity to physical environments against the convenience provided by online recreational environments for interaction and engagement anytime and anywhere.

However, the current online technologies largely focus on chance-based interactions of the users in the recreational environments prioritizing engagement of users by the element of chance and related potential for monetary gains. Therefore, the preference of users for interactive skill-based environments is overlooked, and the users are often left dependent on chance-based interactions, further inducing greater reliance on uncertainty for engaging experiences rather than responsive and strategic actions between users.

Since monetization via these online recreational environments is based on the quantity of assets acquired by each interacting party, skill-integrated environments are desirable for facilitating experience alongside the the desired competitive opportunities and certainty for acquiring requisite assets based on the users' skills. Although certain technologies currently provide skill-based interactions for the recreational environments to certain levels, the existing technologies lack the capability to seamlessly integrate higher quotients of skill-based interactions in the environment.

Thus, there is a need for a multi-user recreational environment to enable users to enhance certainty of acquiring requisite assets during an interactive session to overcome the abovementioned drawbacks.

### SUMMARY OF THE PRESENT INVENTION

In an embodiment of the present invention, a multi-user recreational environment to enable users to enhance certainty of acquiring requisite assets during an interactive session is disclosed. The environment includes an interface module to provide visual components including an array of positioning units, a set of selection objects and one or more categories of user identifiers, to each user in the session via a user device associated with the each user. The environment also includes a communication module to generate varying selection objects for the set, at the initiation of each round of interaction in the session and to receive user input indicative of user preference from the set of the selection objects. The environment further includes a positioning module to reposition at least one first category user identifier associated with a user, within the array of positioning units, based on the received user input associated with the one or more selection objects in the provided set and an event detector to estimate a count of assets to be assigned to one or more users associated with the repositioning of the at least one first category user identifier within the array of positioning units.

In an embodiment of the present invention, the visual components further include user progress indicators and one or more categories of revision objects.

In an embodiment of the present invention, the visual components are provided to the each user based on the number of users in the session and customization data of the each user.

In an embodiment of the present invention, one of: the same set and a different set of selection objects is provided to each of the users engaged in the session.

In an embodiment of the present invention, the user input indicative of user preference from the set of the selection objects and repositioning of the at least one first category user identifier associated with the user input is one of: indicated and hidden to all the other users engaged in the session in real-time.

In an embodiment of the present invention, the communication module is to further receive user input indicative of user preference to regenerate one or more objects from the provided set via selection of one or more categories of revision objects associated with the user.

In an embodiment of the present invention, the all the selection objects available in the set are regenerated for the user selection of a primary revision object.

In an embodiment of the present invention, a specific object selected by the user from the set is regenerated for the user selection of a secondary revision object.

In an embodiment of the present invention, the event detector is to detect a type of positioning event associated with the repositioning of the first category user identifier for estimating the count of assets to be assigned to the one or more users.

In an embodiment of the present invention, the environment further comprises a user coordination module to at least one of: enable and disable in a pre-defined sequence during a round of interaction, the input elements of a certain number of users corresponding to the number of objects in the provided set until all the objects in the set for the round are selected.

In an embodiment of the present invention, during a subsequent round of interaction, the input elements of other users in the pre-defined sequence uncovered in the prior round are at least one of: enabled and disabled in the pre-defined sequence and are then continued with the first user again based on the number of users in the session, in a cyclical pattern, until all the objects in the re-generated set for the round are selected.

In an embodiment of the present invention, the input elements allow selection of at least one of: an object from the provided set, one or more categories of revision objects and one or more primary category user identifiers.

In an embodiment of the present invention, the user coordination module is to further disable an object from the set for selection, to all the users in a round of interaction, upon each selection of an object from the set by a user.

In an embodiment of the present invention, the user coordination module is to further disable a number of objects in the provided set for selection by all the users in a round of interaction, upon occurrence of a corresponding number of end session events for one or more users engaged in the round.

In an embodiment of the present invention, the each user in the session selects an object from the provided set, first among all the users, for equal number of turn events during the various rounds of the session.

In an embodiment of the present invention, a method for enabling users to enhance certainty of acquiring requisite assets during an interactive session in a multi-user recreational environment is disclosed. The method includes providing visual components including an array of positioning units, a set of selection objects and one or more categories of user identifiers, to each user in the session via a user interface associated with the each user. Next, generating varying selection objects for the provided set, at the initiation of each round of interaction in the session. Next, receiving user input indicative of user preference from the set of the selection objects. Next, repositioning at least one first category user identifier associated with a user, within the array of positioning units, based on the received user input associated with the one or more selection objects in the provided set. Thereafter, estimating a count of assets to be assigned to one or more users associated with the repositioning of the at least one first category user identifier within the array of positioning units.

In an embodiment of the present invention, one of: the same set and a different set of selection objects are provided to each of the users engaged in the session.

In an embodiment of the present invention, the method further includes one of: indicating and hiding the user input indicative of user preference from the set of the selection objects and repositioning of the at least one first category user identifier associated with the user within the array of positioning units to all the other users engaged in the session in real-time.

In an embodiment of the present invention, the method further includes regenerating one or more objects from the provided set based on user input provided via selection from the visual components comprising one or more categories of revision objects associated with the user.

In an embodiment of the present invention, the method further includes detecting a type of positioning event associated with the repositioning of the first category user identifier for estimating the count of assets to be assigned to the one or more users.

In an embodiment of the present invention, the method further comprises at least one of: enabling and disabling in a pre-defined sequence, input elements associated with the plurality of users based on at least one of: the number of selection objects in the provided set, the number of users engaged in the session, a type of selection event associated with the user input and the type of positioning event.

In an embodiment of the present invention, the method further includes disabling a selection object from the set during a round of interaction for access to all the users, upon at least one of: selection of the object by a user engaged and occurrence of end session event for a user.

### BRIEF DESCRIPTION OF DRAWINGS

The following drawings are illustrative of preferred embodiments for enabling the present invention and are not intended to limit the scope of the invention. The drawings are not to scale (unless so stated) and are intended for use in conjunction with the explanations in the following detailed description.

FIG. 1 is a block diagram illustrating a multi-user recreational environment to enable users to enhance certainty of acquiring requisite assets during an interactive session in accordance with an embodiment of the present invention; and

FIG. 2 is a flowchart illustrating a method for enabling users to enhance certainty of acquiring requisite assets during an interactive session in a multi-user recreational environment in accordance with an embodiment of the present invention.

### DETAILED DESCRIPTION OF DRAWINGS

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used are for the purpose of describing exemplary embodiments and should not be considered limiting. Thus, the present invention is to be accorded the widest scope encompassing numerous alternatives, modifications, and equivalents consistent with the principles and features disclosed. For the purpose of clarity, details relating to technical material that is known in the technical fields related to the invention have not been described in detail so as not to unnecessarily obscure the present invention.

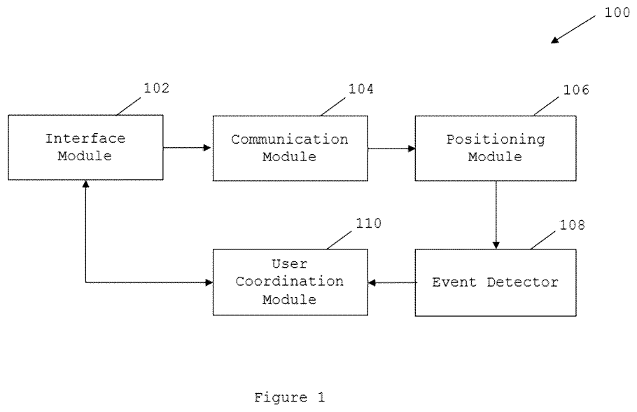

FIG. 1 is a block diagram illustrating a multi-user recreational environment 100 to enable users to enhance certainty of acquiring requisite assets during an interactive session in accordance with an embodiment of the present invention. A recreational environment 100 may include computer-based multimedia with an interactive user interface to allow a user to engage with the environment 100 via a user device. Computer-based multimedia may be understood as multimedia generated by way of processing of information in digital formats and may include without any limitation, computer-generated visuals and computer-generated environment such as virtual reality and augmented reality. The user device may include, without any limitation, a personal computer, a mobile phone and a console. In an embodiment, the user device may be combined with an electronic board for providing an integrated interface for interaction.

Multiple users may interact with each other by collaborative manipulation of digital elements and performing responsive actions in the recreational environment 100 via the interactive user interface. In an embodiment of the present invention, the multiple users may include at least one of: a person and a computer as participants in the environment. For example, a person may interact with a bot in the recreational environment of the present invention. In another embodiment of the present invention, the multiple users may least two persons include at interacting in the environment. Assets may be understood as units of points assigned to a user during an interactive session, and may be indicative of progress of user during the session, the quantity of which may be varied throughout the session based on the interactions of the user.

In an embodiment of the present invention, the recreational environment 100 may be implemented in a plurality of user devices in accordance with the number of users engaged with the recreational environment 100 at an instance during the interactive session. The plurality of user devices may be communicatively coupled to each other via a communication network such as the Internet, and for interaction during a session, the system may facilitate the plurality of users to be added to the session by identifying the users, authenticating if necessary and communicating representational information of the plurality of users across the various user devices associated with the plurality of users in the session. In another embodiment of the present invention, the recreational environment 100 may be implemented in a single user device when a single user may be engaged with a bot in the recreational environment 100.

In an embodiment of the present invention, the

recreational environment 100 may include an interface module 102, a communication module 104, a positioning module 106, an event detector 108 and a user coordination module 110. In an embodiment of the present invention, the interface module 102, the communication module 104, the positioning module 106, the event detector 108 and the user coordination module 110 may be communicatively coupled to a memory and a processor of the user device implementing the recreational environment 100. Further, the processor may be configured to automatically manage the operations of the interface module 102, the communication module 104, the positioning module 106, the event detector 108 and the user coordination module 110.

In an embodiment of the present invention, the processor and the memory may form a part of a chipset installed in the user device implementing the recreational environment 100. In another embodiment of the present invention, the memory may be implemented as a static memory or a dynamic memory. In an example, the memory may be internal to the user device implementing with the recreational environment 100. In another example, the memory may be implemented as an external memory for the user device implementing the recreational environment 100. The memory may be a cloud-based storage or onsite-based storage. Further, the processor may be implemented as one more microprocessors, or microcomputers, microcontrollers, digital signal processors, central processing units, state machines, logic circuitries, or any devices that manipulate signals, based on operational instructions.

In an embodiment of the present invention, the interface module 102 may be configured to provide various visual components to each user in the session, via the respective user interfaces associated with the each user. The visual components may be provided to the each user in accordance with a pre-defined layout, based on the number of users in the session and customization data of the individual users. The visual components may be digital items and may include one or more categories of user identifiers, user progress indicators, a set of selection objects, an array of positioning units and one or more categories of revision objects. The number of first category user identifiers maybe pre-defined based on design configuration. In an exemplary embodiment, each of the users may be provided with 4 first category user identifiers and in another example, each of the users may be provided with 2 first category user identifiers. Further, the first category user identifiers associated with each user may be attributed different colors to represent the associated user. The visual components may be determined and generated by employing technologies including, without any limitation, React JS, Node JS, SpringBoot, Redis, Kafka, MySQL, JAVA.

In an embodiment of the present invention, the interface module 102 may be configured to provide a number of selection objects in the set based on the number of users engaged in the session. The number of selection objects provided within the set may vary with the embodiments. In an exemplary embodiment, the number of users may be 4 and 3 selection objects may be provided to the users in the session. In another exemplary embodiment, the number of users may be 2 and 3 selection objects may be provided to the users in the session. In yet another exemplary embodiment, the number of users may be greater than 4 and 3 selection objects may be provided to the users in the session. In an embodiment of the present invention, the same set of the selection objects may be provided to all the users engaged in the session. In another embodiment of the present invention, different sets of the selection objects may be provided to each of the users engaged in the session. When different sets of selection objects may be provided to each of the users in the session, the provided set of a user may be one of: indicated and hidden to the other users in the session.

The array of positioning units may be indicative of movement range for the users within the recreational environment 100, and at least one positioning unit of the array may be occupied by at least one user at any given instance during the session. The movement of a user within the array may be indicated using a first category of user identifier associated with the user. A second category user identifier of a user may indicate the user's identification details such as a name of the user. Each user in the session may be assigned at least one distinct positioning unit as a starting spot, which may be occupied by one or more first category user identifiers of the respective users at the beginning of the session. Alternatively, all the users engaged in the session may be assigned the same starting spot. At least one other positioning unit of the array may be designated as an ending spot, which upon occupation by all of the first category identifiers associated with one of the users engaged in the session may bring the session to an end. Each user may reach the ending spot by following a movement pattern in the array from the starting spot. In an embodiment of the present invention, any positioning unit in the array may be assigned as the starting point for one or more users.

One or more regular positioning units in the array may be designated as safe spots. Further, all the starting spots may be designated as safe spots. All the safe spots and the ending spot may be designated as exclusive positioning units and the remaining positioning units may be designated as regular positioning units. The values assigned to an exclusive positioning unit may vary from that of a regular positioning unit. The starting spots, the safe spots, the ending spot and the regular positioning units may be distinguishingly indicated to the users.

The session may include multiple sequential rounds of interaction between the users. In an embodiment of the present invention, the communication module 104 may be configured to generate varying selection objects for the set, at the initiation of each round of interaction in the session. The varying objects may indicate, without any limitation, at least one of: numerical values, symbols and pictographs. In an embodiment of the present invention, the communication module 104 may be further configured to receive user input indicative of user preference from the set of selection objects by way of selection of an object from the set.

In an embodiment of the present invention, the communication module 104 may be further configured to receive user input indicative of user preference to regenerate the one or more objects from the provided set via selection of one or more categories of revision objects associated with the user. When a primary revision object may be selected by a user, the communication module 104 may be configured to regenerate all the selection objects available in the set during the selection of the primary revision object. When a secondary revision object may be selected by a user, the communication module 104 may be configured to regenerate a specific object selected by the user during a round of interaction. Numerical values may be generated for the one or more selection objects from the set by employing a random number generator (RNG) which may utilize JAVA's random class. For the varying objects comprising at least one of: a symbol and a pictograph, the associated symbol or pictograph may be pre-assigned a numerical value which may be generated for the object by the RNG.

In an embodiment of the present invention, the positioning module 106 may be configured to reposition at least one first category user identifier associated with a user, within the array of positioning units, based on the received user input indicative of user preference from the generated one or more selection objects in the provided set. The user identifiers may be repositioned in accordance with index values and co-ordinates associated with the positioning units and user identifiers involved, by employing technologies such as React JS including AnimJS and CSS. The repositioned first category user identifier may be any of the first category user identifiers associated with the user and may be selected for the repositioning by the user. The selected at least one first category user identifier maybe repositioned within the array by a number of units in proportion to the value associated with the selected object. In an embodiment of the present invention the user input indicative of user preference from the set of the selection objects and repositioning of the at least one first category user identifier associated with the user input is one of: indicated and hidden to all the other users engaged in the session in real-time.

Each round of interaction may include a series of events. An event in the round may include at least one of: a selection event and a positioning event. The selection event may include selection of an object by a user from the generated one or more selection objects. The positioning event may include repositioning of a first category user identifier based on the value of the object selected by a user. The value of each of the object in the set may be pre-defined. The round may end when all the objects in the provided set that may be available for selection, may be selected by one or more users engaged in the session, followed by corresponding positioning events based on the selection.

In an embodiment of the present invention, the event detector 108 may be configured to detect a type of positioning event associated with a first category user identifier when the user identifier may be repositioned. The first type of positioning event may include an action of repositioning to one of: an unoccupied regular positioning unit, the ending spot and a regular positioning unit previously occupied by another first category user identifier of the same user. The positioning unit which may be previously occupied by a first category user identifier of the same user, to which another first category user identifier of the same user is repositioned, may be designated as a safe unit until the at least two first category user identifiers of the same user are positioned in the same positioning unit. Alternatively, the positioning unit which may be previously occupied by at least two first category user identifiers of one user, to which one or more first category user identifiers of at least one of: the same user and a different user may be repositioned, may be designated as the safe unit until at least two first category user identifiers of at least one of: the same user, the different user and a combination thereof, are positioned in the same positioning unit.

During the selection for repositioning, the server associated with the system 100 provides values for selection objects along with a state array which may be, for example [0, 0, 1], for a set of three selection objects where “0” means the object can be selected and “1” means it cannot. When the user may select an object from the set, the user device sends both the index and the object's value back to the server. This selection where the available objects are identified first, is unique to the present invention.

The second type of positioning event may include an action of repositioning of a first category user identifier of one user to a regular positing unit in the array, which may follow another action of previous occupation of the regular positioning unit by a first category user identifier of another user. A third type of positioning event may include an action of repositioning of a first category user identifier of one user to a safe unit in the array, which may follow another action of previous occupation of the safe unit by a first category user identifier of another user. A fourth type of positioning event may include repositioning of a first category user identifier of one user to a regular positing unit in the array, which may follow another action of previous occupation of the regular positioning unit by at least two first category user identifiers of another user.

In an embodiment of the present invention, the event detector 108 may be configured to assign a number of assets to a user based on the repositioning of at least one first category user identifier associated with the user during a positioning event. The number of assets assigned to the user may be based on the value assigned to the positioning units that may be traversed by the at least one first category user identifier associated with the user during the positioning event. In an embodiment of the present invention, the event detector 108 may be further configured to estimate a count of assets to be assigned one or more users associated with a positioning unit at an instance during the session, based on the detected type of the positioning event. In an embodiment of the present invention, the each user may be assigned zero as the number of assets at the beginning of the session. In another embodiment of the present invention, the each user may be assigned a pre-defined number of assets at the beginning of the session.

When the first type of positioning unit may occur, the count of assets assigned to the user repositioning during the event may be an aggregate sum of values assigned to all the positioning units traversed by the first category user identifier associated with the user during the positioning event. For example, when a first category user identifier of a user may be repositioned to a regular positioning unit that is five units away, wherein each regular positioning unit may be assigned a value of two each, 10 assets may be assigned to the user for the positioning event. In another example, when a first category user identifier of a user may be repositioned to the ending spot, the aggregate amount of assets of the user may be incremented by a value that may be several multiples of a single regular positing unit in the array.

When the second of type of the positioning event may occur, the total count of assets assigned to the associated second user (previously occupying the positioning unit) via traversal of the first category user identifier (associated with the positioning event), of the second user in the array from the initiation of the session may be estimated. The estimated count of assets assigned to the second user via the first category user identifier associated with the second type of event from the initiation of the session, may be deducted from the aggregate assets of the second user. Further, when second type of positioning event may occur, the positioning module (106) may be configured to reposition the first category user identifier of the first positioned user to the starting spot of the first user. Further, when one of: the second type, the third type and the fourth type of positioning event may occur, the count of assets assigned to the primary user associated with repositioning during the event may be an aggregate sum of values assigned to all the positioning units traversed by the first category user identifier associated with the user during the positioning event.

When at least one of: the third type and the fourth type of the positioning events may occur, the positions of the first category user identifiers of the user previously occupying the positioning unit associated with the event may remain unaltered. Further, no assets may be deducted from the aggregate assets of the user previously occupying the positioning unit associated with the at least one of: the third type and the fourth type of positioning event.

In an embodiment of the present invention, the event detector 108 may be further configured to estimate an aggregate count of assets acquired by the one or more users in the session based on the count of assets assigned to the users or deduced from the users, for the each positioning event during the session and update the progress indicator of the each user based on the aggregate count of assets acquired by the each user.

At the end of the session, when all the first category identifiers associated with one of the users may occupy the ending spot, the event detector 108 may be configured to identify one or more users that acquired the largest amount of aggregate assets by comparing the progress indicators of all the users engaged in the session. Certain resources may automatically be granted to the identified one or more users. Resource may be any source of value and may include without any limitation, monetary source, merchandise, educational materials and token of acknowledgement.

In an embodiment of the present invention, the user coordination module may be configured to enable and disable in a pre-defined sequence, input elements associated with the plurality of users based on at least one of: the number of selection objects in the provided set, the number of users engaged in the session, the type of selection event and the type of positioning event. The input elements may allow selection of at least one of: an object from the provided set, one or more categories of revision objects and one or more primary category user identifiers. At the initiation of a round of interaction, when a plurality of selection objects in the provided set may be generated, the input elements of a first user in the pre-defined sequence may be enabled while the input elements of the remaining users may be disabled. The input elements may be disabled for a user by disabling the user interface and blocking web socket requests of the associated user.

Upon detection of one of: a turn event and a lapse event associated with the first user, the input elements of a second user in the pre-defined sequence may be enabled for selection of an object from the provided set while the input elements of the remaining users including the first user may be disabled. A turn event may include one selection event and at least one consequent positioning event. During the round of interaction, the input elements of a certain number of users corresponding to the number of objects in the defined set may be continued to be enabled and disabled in aforementioned sequence until all the objects in the defined set may be selected. Upon selection of an object from the set by a user, the selected object may be disabled for access to the other users in the round.

The second round may include enabling and disabling of input elements of other users in the pre-defined sequence uncovered in the prior round and then continuing with the first user again, in a cyclical pattern, for selection from the re-generated objects of the second round. The subsequent rounds may continue to repeat the enabling and disabling of input elements of all users engaged in the session in a cyclical pattern as aforementioned until the end of the session.

In an embodiment of the present invention, the user coordination module may be further configured to detect one of: a type of selection event, a type of positioning event and a lapse event associated with the user based on a user input. A first type of selection event may include selection of an object with a value below a certain pre-defined threshold. A second type of selection event may include selection of an object with a pre-defined value. For example, the second type of selection event may include selection of an object indicative of a numerical value 6 and the first type of selection event may include selection of an object indicative of a numerical value below 6.

During a turn event of a user, upon the occurrence of a selection event and a consequent positioning event, the user coordination module may be further configured to enable input elements of the same user for selection of the second category revision object, based on detection of one of: the second type of selection event, the second type of positioning event and the first type of positioning event associated with an ending spot. Upon selection of the secondary revision object by the user, the communication module 104 may regenerate a value of the object selected by the user during the selection event and based on the regenerated value, a selected first category user identifier of the user may be repositioned.

Even when the input elements associated with the secondary revision object may be enabled to the user based on detection of at least two of the above events, the input elements may be enabled for only one such consequent selection of the secondary revision object. Upon regeneration of an object after selection of the secondary revision object, for a consequent second type of selection event, the input elements associated with the secondary revision object may be re-enabled. For a pre-defined number of subsequent occurrences of the second type of selection events, during the each subsequent selection of the secondary revision object, the enabling of the input elements for the consequent selection of the secondary revision object may be limited to a pre-defined value.

In an embodiment of the present invention, the user coordination module may be configured to track the number of turn events associated with the each user in the session. In an embodiment of the present invention, the number of rounds in the session may be limited based on occurrence of one of: lapse of the pre-defined time-limit of the session and end session events for at least one of the users in the session. In an embodiment of the present invention, the session may end for all the users upon lapse of the pre-defined time-limit of the session. When all the first category user identifiers of a user are positioned at the ending spot during a round, the session may end after completion of turn events of one or more subsequent users such that the each user in the session may select an object first among all the users for equal number of turn events during the various rounds of the session. For example, when the pre-defined time-limit of the session may lapse, the session may continue until it may be determined that each user in the session has selected an object first among all the users for equal number of turn events during the various rounds of the session.

In an embodiment of the present invention, when at the end of the session, when the pre-defined time-limit of the session lapses, the event detector 108 may be configured to identify one or more users that acquired the largest amount of aggregate assets by comparing the progress indicators of all the users engaged in the session.

When one or more users may be assigned an end session event, the assigned users may be dropped from the sequence and the sequence with the remaining users may be continued to be used for the enabling and disabling of the input elements. The end session event of a user may include a state of the user when the user may no longer continue to interact in the session and the other users in the session may be disallowed to interact with the user. Further, the aggregate count of assets acquired by the user associated with the end session event may be set to zero. In a round of interaction, when one or more end session events may be attributed to one or more users, the coordination module may be configured to disable a corresponding number of objects in the provided set for selection by all the users in the round of interaction. For example, in a session with four users and a set of three selection objects, if the fourth user in the sequence may be attributed an end session event, the fourth user may be dropped from the session and one object from the set of three objects may be disabled for selection for the remaining 3 users. The object disabled for selection may be the object with the highest value in the set.

In an embodiment of the present invention, an end session event may be attributed to a user on occurrence of a pre-defined number of lapse events. A lapse event may include failure of a user to select an object from the provided set within a pre-defined duration provided for the selection, during which input elements of the user may be enabled. When the user coordination module may detect a pre-defined number of lapse events from a user, an end session event may be attributed to the user and the input elements of the user may further be disabled for the rest of the session. A lapse event occurring due to technical reasons associated with the user device implementing the present invention may be also be counted for attributing the end session event.

In an embodiment of the present invention, the user coordination module may be further configured to monitor the number of selections of at least one of: selection objects and each of the revision objects by each user from the initiation of the session. In an embodiment of the present invention, an end session event may be attributed to a user when the monitored number of selections of objects from the set of the certain user may exceed a pre-defined number. The number of selections of the revision objects available to a user during a session may be pre-defined for all the users in the session of interaction. The monitored data may be provided to the corresponding users via the respective user interfaces. The number of selections of the primary revision object by a user may be limited to a pre-defined number.

In an embodiment of the present invention, when the end session event may be attributed to the user based on the monitored number of selections of the objects, upon completion of subsequent turn events of the remaining users in the session, based on the monitored number of selections of the objects of the remaining users, when the pre-defined selection limit for all the user lapses, the session may end for all the users and the event detector 108 may be configured to identify one or more users that acquired the largest amount of aggregate assets by comparing the progress indicators of all the users engaged in the session. In an exemplary embodiment, the pre-defined selection limit for the users may be 24 and the number of rounds for the session may be 8. In another exemplary embodiment, the pre-defined selection limit for the users may be 30 and the number if round for the session may be 10.

In an embodiment of the present invention, each user may be provided at the initiation of the session, with an extension option for increasing the duration of a lapse event for a user, by a pre-defined value. The extension option may be automatically enabled for use by a user upon occurrence of a first lapse event of the user. Upon lapsing of the pre-defined duration provided via the extension option, the end session event may be attributed to the user and the input elements of the user may further be disabled for the rest of the session. Alternatively, the extension option may be enabled for selection by user upon occurrence of a pre-defined number of lapse events.

In an example scenario when two users may be engaged in the recreational environment 100, if one user may be attributed an end session event, the other user may be automatically identified as the user with the largest assets even if the count of assets of the first user may be larger than the second player before assigning of the end session event to the first user. In an embodiment of the present invention, the total duration of the interactive session may be pre-defined.

When the repositioning of a first category user identifier associated with a user may be unavailable based on the value of the each object available for user selection from the provided set of selection objects, the user may select the primary revision object, if the number of selections of the primary revision object may be not yet be exhausted. In such a scenario when a user may choose the primary revision object, the selection objects in the provided set may be regenerated. Alternatively, the user may elect for a lapse event to occur. In such a case when the user may elect for a lapse event during non-feasibility of repositioning based on the available values for selection, such lapse events may not be taken into consideration for assigning the end session event to the corresponding user.

When the repositioning of a first category user identifier associated with a user may continue to regenerated objects be unavailable based on the available for user selection from the provide set, the user may elect the for lapse event. When the repositioning of a first category user identifier associated a user may continue to be unavailable after at least one of: selection of the primary revision object and election for the lapse event, the selection objects may be regenerated at the end of an on-going round for providing new set of values for the user selection.

Further, the duration being taken by a user to select an object from the provided set until the occurrence of an associated lapse event, may be continuously indicated to the user as visual components, in real-time, for the period of which, the input elements of a user for selection of an object may be enabled and upon failure to provide input within the pre-defined duration the input elements may be disabled.

In an embodiment of the present invention, the pre-defined safe spots may be absent. In an embodiment of the present invention, the secondary revision object maybe enabled for selection based on at least one of: the count of turn events, the type of selection of event and the type of positioning event. In an embodiment of the present invention, two or more users may be grouped together to interact in the session as groups. When the users may interact in a group of two or more users, the one or more users that acquired the largest amount of assets may be identified based on aggregate count of assets of all the users in the each group. In an embodiment of the present invention, when different sets of selection objects are provided to the users, during each round of interaction in the session, the one or more users may select from their individual sets of selection objects. In this case, for every turn event of a user during a round, one object from the user's set may be selected and remaining objects in the set may be selected by the user in subsequent turn events in the round after the completion of the turn events of the other players.

In an embodiment of the present invention, a first category user identifier may be repositioned subsequently more than once for every selection event. In an embodiment of the present invention, when a second type of positioning event occurs, the first category user identifier previously occupying the positioning unit may remain unaffected for one of: a pre-defined count of turn events and a pre-defined duration. In an embodiment of the present invention, the user may provide multiple selection inputs during the selection of an object from the set and the repositioning may be based on the last provided input, prior to the selection of the first category user identifier for the positioning event.

In an embodiment of the present invention, the present invention may be implemented in part in a user device and in part in an electronic board. The interaction of the users by way of the electronic board may be via one or more distinct articles associated with each of the users. The electronic board may be provided with the array of positioning units and one or more other categories of visual components in the form of one of: the digital elements and physical elements, for facilitating interaction of the one or more users via the electronic board. The electronic board may be configured to detect the positions of the one or more articles of the users on the electronic board via a plurality of sensors when the one or more articles may be repositioned by the users manually on the electronic board, based on the set of selection objects provided to the users on the user device. Assets may be assigned to the one or more users in the session based on the detected positions of the one or more articles on the electronic board.

In operation, when multiple users may initiate a session for engaging in the recreational environment 100 of the present invention, the interface module 102 may provide various visual components to each user in via the respective user interfaces the session, associated with the each user. The visual components may be provided with a pre-defined layout, based on the number of users and their customization data. The visual components may include one or more categories of user identifiers, user progress indicators, a set of selection objects, an array of positioning units and one or more categories of revision objects.

Upon providing the visual components, the communication module 104 may generate varying selection objects for the set, at the first round of interaction in the session and then, the user coordination module may enable input elements of a first user in a pre-defined sequence. The communication module 104 may then receive user input indicative of user preference from the set of selection objects from a first user. Then, the positioning module 106 may reposition one first category user identifier associated with the first user, within the array of positioning units, based on the received user input.

The event detector 108 may then detect a type of positioning event associated with the first category user identifier of the first user that is repositioned. The event detector 108 may then assign a number of assets to a user based on the repositioning of the first category user identifier associated with the first user, based on the value assigned to the positioning units and the type of positioning event occurred.

The user coordination module may also detect one of: a type of selection event, a type of positioning event and a lapse event associated with the user based on the first user's input and then user coordination module may further enable input elements of the same user for selection of the second category revision object, based on detection of one of: the second type of selection event, the second type of positioning event and the first type of positioning event associated with an ending spot. Upon selection of the secondary revision object by the user, the communication module may regenerate a value of the object selected by the user during the selection event and based on the regenerated value, a selected first category user identifier of the user may be repositioned. Alternatively, the first user may select a primary revision object and, the communication module 104 may regenerate all the selection objects available in the set during selection of the primary revision object.

Upon detection of one of: a turn event and a lapse event associated with the first user, the input elements of a second user in the pre-defined sequence may be enabled for selection while the input elements of the remaining users including the first user may be disabled. The input elements of a certain number of users corresponding to the number of objects in the defined set may be continued to be enabled and disabled in aforementioned sequence until all the objects in the defined set may be selected during the first round.

The communication module 104 may generate varying selection objects for the set, for the second round which may include enabling and disabling of input elements of other users in the pre-defined sequence uncovered in the prior round and then continuing with the first user again, in a cyclical pattern, for selection from the re-generated objects of the second round. The subsequent rounds may continue to repeat the enabling and disabling of input elements of all users engaged in the session in a cyclical pattern as aforementioned until the end of the session.

The user coordination module may simultaneously track the number of turn events associated with the each user in the session, and the session may end for all the users upon lapse of the pre-defined time-limit of the session. Alternatively, the session may end, when all the first category identifiers associated with one of the users may occupy the ending spot. At the end of the session, the event detector 108 may identify one or more users that acquired the largest amount of aggregate assets by comparing the progress indicators of all the users engaged in the session.

In an example scenario, multiple users may initiate a session in the recreational environment 100 of the present invention for engaging in an educational activity. For example, if four users are in the session, the interface module 102 may provide the various visual components to the four users. Upon providing the visual components, the communication module 104 may generate varying selection objects for the set at the first round of interaction in the session and then, the user coordination module may enable input elements of a first user in a pre-defined sequence. The selection objects may in this example include various pictographs indicative of different questions on a subject. The communication module 104 may then receive user input indicative of user preference from the set of pictographs from a first user. Then, the positioning module 106 may reposition one first category user identifier associated with the first user, within the array of positioning units, based on the received user input. In this example, based on the response to the question received from the user and the value assigned to the response, the first category user identifier may be repositioned.

The event detector 108 may then detect a type of positioning event and may then assign a number of assets to the first user based on the repositioning. Upon detection of one of: a turn event and a lapse event associated with the first user, the input elements of a second user in the pre-defined sequence may be enabled for selection and the second user may select another pictograph from the set of objects. Based on the selected pictograph, the user may be provided with a question on the subject and based on the value assigned to the received response to the question from the second user, the first category user identifier of the second user may be repositioned. Then, for example, if three objects may be provided in the set and four users are engaged, the third pictograph may be selected by the third user and the round may end. In the subsequent round, another set of objects may be regenerated, and now the fourth user may first select from the provided pictographs in this example. The subsequent rounds may continue to repeat the enabling and disabling of input elements of all four users engaged in the session in a cyclical pattern as aforementioned until the end of the session. At the end of the session, the event detector 108 may identify one or more users that acquired the largest amount of aggregate assets by comparing the progress indicators of all the users engaged in the session.

In another example scenario, multiple users may initiate a session in the recreational environment 100 of the present invention for engaging in another educational activity. In the session, the interface module 102 may provide the various visual components to the users and the communication module 104 may generate varying selection objects for the set at the first round of interaction in the session. The selection objects may in this example include various educational tools. The communication module 104 may then receive user input indicative of user preference from the set of educational tools from a first user. The first user may then be directed to navigate through one or more modular challenges and then, the positioning module 106 may reposition one first category user identifier associated with the first user, within the array of positioning units, based on the completion of the challenges.

The event detector 108 may then detect a type of positioning event and may then assign a number of assets to the first user based on the repositioning. Upon detection of one of: a turn event and a lapse event associated with the first user, the input elements of a second user in the pre-defined sequence may be enabled for selection and the second user may select another education tool from the set of objects. Based on the selected tool, the user may be provided with a modular challenge and based on the value assigned to the challenge, the first category user identifier of the second user may be repositioned. By completing the modular challenges with the selected educational tools, the users may solve problems collaboratively and progress further in the session.

In another example scenario, multiple users may initiate a session in the recreational environment 100 of the present invention for engaging in teams. For example, if four users are in the session, the users may be divided into two teams of two users each and the interface module 102 may provide the various visual components to the two teams. Upon providing the visual components, the communication module 104 may generate varying selection objects for the set. The selection objects may in this example include various numerical values. The communication module 104 may then receive user input indicative of user preference from the set of symbols from a user from first team. Then, the positioning module 106 may reposition one first category user identifier associated with the user from the first team, based on the received user input. The event detector 108 may then detect a type of positioning event and may then assign a number of assets to the first team based on the repositioning. Upon detection of one of: a turn event and a lapse event associated with the first team, a user from the second team may select another object with a numerical value. Based on the selected numerical value, the first category user identifier of the user of the second team may be repositioned. At the end of the session, the event detector 108 may identify the team that acquired the largest amount of aggregate assets.

In another example scenario, multiple users may initiate a session in the recreational environment 100 of the present invention for engaging in a group activity for a task completion. For example, if five users are in the session, the interface module 102 may provide the various visual components to the five users. Upon providing the visual components, the communication module 104 may generate varying selection objects for the set. The selection objects may in this example include various symbols indicative of different parts of the task to be completed. The communication module 104 may then receive user input indicative of user preference from the set of symbols from a first user. Then, the positioning module 106 may reposition one first category user identifier associated with the first user, based on the received user input. In this example, based on the time taken for the first user to complete the task and the value assigned to the time taken, the first category user identifier may be repositioned.

The event detector 108 may then detect a type of positioning event and may then assign a number of assets to the first user based on the repositioning. Upon detection of one of: a turn event and a lapse event associated with the first user, the second user may select another object with a symbol indicating another part of the task. Based on the selected symbol, the second user may be provided with a sub-task and based on the time taken by the second user to complete the sub-task, and the value assigned to the time taken for the sub-task completion, the first category user identifier of the second user may be repositioned. In this example the each user may provide input indicative of completion of the selected sub-task and the time taken to receive the input may be automatically monitored. Alternatively, when the sub-task completion may be automatically identified.

In this example, if two objects may be provided in the set and five users are engaged, the round may end after selection by the second user and in the second round, another set of objects may be regenerated, and now the third user may first select from the provided symbols in this example. The subsequent rounds may continue to repeat the enabling and disabling of input elements of all five users engaged in the session in a cyclical pattern. At the end of the session, the event detector 108 may identify one or more users that acquired the largest amount of aggregate assets.

In yet another example scenario, multiple users may initiate a session in the recreational environment 100 of the present invention for engaging in a game. For example, if two users are in the session, the interface module 102 may provide the various visual components to the two users. Upon providing the visual components, the communication module 104 may generate varying selection objects in a set, at the first round and then, the user coordination module may enable input elements of a first user. The selection objects may in this example include various numerical values. The communication module 104 may then receive user input indicative of user preference from the set of numerical values. Then, the positioning module 106 may reposition one first category user identifier associated with the first user, within the array of positioning units, based on the received numerical value.

The event detector 108 may then detect the type of positioning event and may then assign a number of assets to the first user, based on the value assigned to the positioning units and the type of positioning event occurred. For example, when a first type of positioning event may be detected, comprising an action of repositioning to an unoccupied regular positioning unit traversing six units, if each traversed is assigned a value of 5, the total of 30 assets maybe assigned to the first user.

The user coordination module may also detect one of: a type of selection event, a type of positioning event and a lapse event associated with the user based on the first user's input and then user coordination module may further enable input elements of the same user for selection of the second category revision object, based on detection of one of: the second type of selection event, the second type of positioning event and the first type of positioning event associated with an ending spot. For example, if the user input may be a pre-defined value, the user coordination module may further enable input elements of the first user for selection of the second category revision object. In this example if the pre-defined value is 6 and the user has selected the numerical value 6 from the set of objects, the input elements may be re-enabled for selection of regeneration of another value for the same object that is initially selected.

Upon detection of one of: a turn event and a lapse event associated with the first user, the input elements of a second user in the pre-defined sequence may be enabled for selection. The first user and the second user may continue to select objects and reposition their respective first category of user identifiers, until all the objects in the defined set may be selected during the first round.

The communication module 104 may generate varying selection objects for the set, for the second round which may include enabling and disabling of input elements of both the users in the pre-defined sequence, which in this example, alternates between the users, for selection of the re-generated numerical values of the second round. The subsequent rounds may continue to repeat the enabling and disabling of input elements in a cyclical pattern as aforementioned until the end of the session. During any round, the each user may select a primary revision object according their requirement of the numerical values for repositioning and, the communication module 104 may then regenerate the numerical values of all the selection objects available in the set upon such selection of the primary revision object by a user. Thereafter, at the end of the session, the event detector 108 may identify one or more users that acquired the largest amount of aggregate assets and automatically grant pre-defined resources to the identified one or more users.

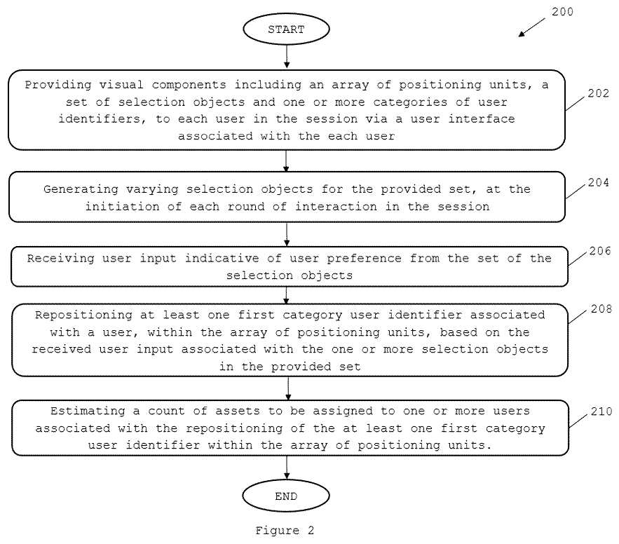

FIG. 2 is a flowchart illustrating a method for enabling users to enhance certainty of acquiring requisite assets during an interactive session in a multi-user recreational environment in accordance with an embodiment of the present invention. The method starts at step 202. At step 202, visual components including an array of positioning units, a set of selection objects and one or more categories of user identifiers, may be provided to each user in the session via a user interface associated with the each user.

At step 204, varying selection objects may be generated for the provided set, at the initiation of each round of interaction in the session. One of: the same set and a different set of selection objects are provided to each of the users engaged in the session. At step 206, user input indicative of user preference from the set of the selection objects may be received.

At step 208, at least one first category user identifier associated with a user may be repositioned, within the array of positioning units, based on the received user input associated with the one or more selection objects in the provided set. Thereafter, at step 210, a count of assets to be assigned to one or more users associated with the repositioning of the at least one first category user identifier within the array of positioning units may be estimated.

In an embodiment of the present invention, the method further includes one of: indicating and hiding the user input indicative of user preference from the set of the selection objects and repositioning of the at least one first category user identifier associated with the user within the array of positioning units to all the other users engaged in the session in real-time.

In an embodiment of the present invention, the method further includes regenerating one or more objects from the provided set based on user input provided via selection from the visual components comprising one or more categories of revision objects associated with the user.

In an embodiment of the present invention, the method further includes detecting a type of positioning event associated with the repositioning of the first category user identifier for estimating the count of assets to be assigned to the one or more users.

In an embodiment of the present invention, the method further comprises at least one of: enabling and disabling in a pre-defined sequence, input elements associated with the plurality of users based on at least one of: the number of selection objects in the provided set, the number of users engaged in the session, a type of selection event associated with the user input and the type of positioning event.

In an embodiment of the present invention, the method further includes disabling a selection object from the set during a round of interaction for access to all the users, upon at least one of: selection of the object by a user engaged and occurrence of end session event for a user.

Thus, the present invention provides a multi-user recreational environment to enable users to enhance certainty of acquiring requisite assets during interactive session. Since all the users in a round of interaction select from a common set of selection objects, one user may influence the progression of the other users as the selection of an object by a first user may be such that it negatively affects the progress of one or more other users based on the objects remaining for the other users' selection, while positively impacting the first user. Therefore, the reliance on a single random value generation for all the users, which is conventionally seen is eliminated and strategy-based interaction is promoted due to the set of objects provided by the present invention. Since the common set is provided for each selection by the different users in a round, the number of separate random value generations for the each user is avoided, thereby reducing the processing power consumption by the user devices engaged in the session.

Further since the selection objects may be re-generated for each round of interaction, the present invention allows for dynamic analysis of the on-going interaction between the users thus improving engagement in the recreational environment. Further since revision objects are provided to the each user for regenerating the one or more selection objects as per user requirement, each user may influence the values of the selection objects made available in both individual selection cases and the overall selections by multiple users in a round, at critical times, to quickly affect a current stage of interaction as well as the direction of an ending of the interactive session. Thus, the competitive aspect of the interaction is further enhanced.

Further since the RNG is used for automatic generation of the varying numerical values for the selection objects at the beginning of every round of interaction, the burden of generating varying values for each round is removed from the users and wastage of time by a user by waiting for a long time to select to regenerate a value for the individual user as in the conventional environments is avoided. Since multiple selections for value generations from each user is eliminated in the present invention, the amount of data for transmission by the communication network and consequent amount of data to be processed is reduced. Further since the number of selection objects provided to the users is dependent on the number of users involved, and since the input elements of the users are enabled and disabled in a pre-defined sequence, each user is given equal opportunity to make a first selection for influencing the subsequent movements of the involved users in the round by re-generating a new set of selection objects during each round.

Since the duration for which the input elements of a user are enabled for making a selection of an object is limited, the users are prevented from purposefully wasting time on selection and reducing the other users' time for subsequent interactions in a time-based interactive session. Even when a user may fail to make a selection within the pre-defined duration leading to a lapse event, the same user can continue with selection in the subsequent rounds ensuring continued interaction of the user in the session. Since the set of objects are provided to all users engaged in the session, the present invention allows the users to analyze and strategize beforehand, thus reducing the amount of time taken to provide input for selecting the object. Therefore, the time taken by users during the interaction may be reduced and the session may consequently take less time and thus, the overall energy consumption of the user devices of the users is reduced.

Since the progress of a user is affected by the type of selection events and the positioning events occurring in a round of interaction, the present invention enables the user to progress based on careful analysis of the opted events and consequent movements, thus, reducing uncertainty in acquiring the required assets for a user. Therefore, the present invention facilitates a user to acquire the highest aggregate amount of assets amongst all the users by largely relying on analysis and strategic planning of the interaction and reduced reliance on the chance.

The present invention allows the users to assess beforehand, the impact of one user's selection of a particular object on the positioning of the users' identifiers in the array, such as reaching a particular unit with high positioning values, to safe units, events leading to reduction of assets. This further enhances the certainty of acquiring the assets or progress of the users besides facilitating effective interaction. Further, since a user finding a desired object from the various selection objects for every round is not equally high, the present invention allows the user to plan the movement pattern to reach the ending spot from the beginning of the session, by avoiding adverse events based on the skill of the user, to remain as a user with leading number assets throughout the session.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A multi-user recreational environment (100) to enable users to enhance certainty of acquiring requisite assets during an interactive session, the environment (100) comprising:
an interface module (102) to:
provide visual components including an array of positioning units, a set of selection objects and one or more categories of user identifiers, to each user in the session via a user device associated with the each user;
a communication module (104) to:
generate varying selection objects for the set, at the initiation of each round of interaction in the session;
receive user input indicative of user preference from the set of the selection objects;
a positioning module (106) to:
reposition at least one first category user identifier associated with a user, within the array of positioning units, based on the received user input associated with the one or more selection objects in the provided set; and
an event detector (108) to:
estimate a count of assets to be assigned to one or more users associated with the repositioning of the at least one first category user identifier within the array of positioning units.

2. The environment (100) as claimed in claim 1, wherein the visual components further include user progress indicators and one or more categories of revision objects.

3. The environment (100) as claimed in claim 1, wherein the visual components are provided to the each user based on the number of users in the session and customization data of the each user.

4. The environment (100) as claimed in claim 1, wherein one of: the same set and a different set of selection objects is provided to each of the users engaged in the session.

5. The environment (100) as claimed in claim 1, wherein the user input indicative of user preference from the set of the selection objects and repositioning of the at least one first category user identifier associated with the user input is one of: indicated and hidden to all the other users engaged in the session in real-time.

6. The environment (100) as claimed in claim 1, wherein the communication module (104) is to further receive user input indicative of user preference to regenerate one or more objects from the provided set via selection of one or more categories of revision objects associated with the user.

7. The environment (100) as claimed in claim 6, wherein the all the selection objects available in the set are regenerated for the user selection of a primary revision object.

8. The environment (100) as claimed in claim 6, wherein a specific object selected by the user from the set is regenerated for the user selection of a secondary revision object.

9. The environment (100) as claimed in claim 1, wherein the event detector (108) is to detect a type of positioning event associated with the repositioning of the first category user identifier for estimating the count of assets to be assigned to the one or more users.

10. The environment (100) as claimed in claim 1, further comprises a user coordination module (110) to at least one of: enable and disable in a pre-defined sequence during a round of interaction, the input elements of a certain number of users corresponding to the number of objects in the provided set until all the objects in the set for the round are selected.

11. The environment (100) as claimed in claim 10, wherein during a subsequent round of interaction, the input elements of other users in the pre-defined sequence uncovered in the prior round are at least one of: enabled and disabled in the pre-defined sequence and are then continued with the first user again based on the number of users in the session, in a cyclical pattern, until all the objects in the re-generated set for the round are selected.

12. The environment (100) as claimed in claim 10, wherein the input elements allow selection of at least one of: an object from the provided set, one or more categories of revision objects and one or more primary category user identifiers.

13. The environment (100) as claimed in claim 10, wherein the user coordination module (110) is to further disable an object from the set for selection, to all the users in a round of interaction, upon each selection of an object from the set by a user.

14. The environment (100) as claimed in claim 10, wherein the user coordination module (110) is to further disable a number of objects in the provided set for selection by all the users in a round of interaction, upon occurrence of a corresponding number of end session events for one or more users engaged in the round.

15. The environment (100) as claimed in claim 1, wherein the each user in the session selects an object from the provided set, first among all the users, for equal number of turn events during the various rounds of the session.

16. A method for enabling users to enhance certainty of acquiring requisite assets during an interactive session in a multi-user recreational environment (100), the method comprising:
providing visual components including an array of positioning units, a set of selection objects and one or more categories of user identifiers, to each user in the session via a user interface associated with the each user;
generating varying selection objects for the provided set, at the initiation of each round of interaction in the session; and
receiving user input indicative of user preference from the set of the selection objects;
repositioning at least one first category user identifier associated with a user, within the array of positioning units, based on the received user input associated with the one or more selection objects in the provided set; and
estimating a count of assets to be assigned to one or more users associated with the repositioning of the at least one first category user identifier within the array of positioning units.

17. The method as claimed in claim 16, wherein one of: the same set and a different set of selection objects are provided to each of the users engaged in the session.

18. The method as claimed in claim 16, further includes one of: indicating and hiding the user input indicative of user preference from the set of the selection objects and repositioning of the at least one first category user identifier associated with the user within the array of positioning units to all the other users engaged in the session in real-time.

19. The method as claimed in claim 16, further includes regenerating one or more objects from the provided set based on user input provided via selection from the visual components comprising one or more categories of revision objects associated with the user.

20. The method as claimed in claim 16, further includes detecting a type of positioning event associated with the repositioning of the first category user identifier for estimating the count of assets to be assigned to the one or more users.

21. The method as claimed in claim 16, further comprises at least one of: enabling and disabling in a pre-defined sequence, input elements associated with the plurality of users based on at least one of: the number of selection objects in the provided set, the number of users engaged in the session, a type of selection event associated with the user input and the type of positioning event.

22. The method as claimed in claim 16, further includes disabling a selection object from the set during a round of interaction for access to all the users, upon at least one of: selection of the object by a user engaged and occurrence of end session event for a user.
